(19) United States
(12) Patent Application Publication
(10) Pub. No.: US 2015/0120663 A1
(43) Pub. Date: Apr. 30, 2015

(54) METHOD OF DATA STORING AND DATA SYNCHRONIZATION IN A DISTRIBUTED DATA STORAGE SYSTEM

(71) Applicant: THOMSON LICENSING, Issy de Moulineaux (FR)

(72) Inventors: Nicolas Le Scouarnec, Liffre (FR); Gilles Straub, Acigne (FR); Erwab Le Merrer, Rennes (FR)

(21) Appl. No.: 14/404,732

(22) PCT Filed: May 23, 2013
(86) PCT No.: PCT/EP2013/060625

§ 371 Date: Dec. 1, 2014

(30) Foreign Application Priority Data
Jun. 1, 2012 (EP) 12305615.2

(51) Int. Cl. G06F 17/30; H04L 29/08

(52) U.S. Cl. CPC G06F 17/30174; H04L 67/10
USPC 707/638

(57) ABSTRACT

The present invention generally relates to distributed data storage systems, where different devices manipulate data shared by these devices. In particular, the technical field of the present invention is to related storing of data in a distributed data storage system and associated data synchronization for devices connecting to such a system.

### 1. FIELD OF INVENTION

The present invention generally relates to distributed data storage systems, where different devices manipulate data shared by these devices. In particular, the technical field of the present invention is related to storing of data in a distributed data storage system and associated data synchronization for devices part of such a system.

### 2. TECHNICAL BACKGROUND

As more and more complex consumer electronic devices, capable of generating, receiving and transmitting files are provided with network connectivity: smart phones, tablet PCs, desktop PCs, sharing data between these devices has become an important issue. Current solutions often rely on transmission via e-mail, SMS (Short Message Service) for relatively small files and FTP (File Transfer Protocol), USB flash drive memory for relatively larger files. The file exchange implies manual copying and deletion of files in order to keep a shared set of files coherent between the different devices. This manual management of data is error-prone when different users share a same collection of files: there is a risk of overwriting newest file with older ones, a risk of forgetting to back up files. Finally, the sharing of a common set of files boils down to the same problem of how to keep multiple copies of a shared data set coherent. In the software development environment, where multiple developers work on a same software product, solutions exist (version control) that are however not adapted to a consumer electronics environment because they are too complex to manipulate and offer many functionalities that are not useful in such an environment. Other current solutions exist that are better adapted to an environment where consumer electronics devices are used, e.g. Dropbox, Wuala or Photostream. However, these tools require a central server as a common reference point for the shared data and do not allow a decentralized operation where any device can synchronize with any other device of the shared data community while shared data remains coherent and which operation remains automatic, i.e. without user intervention to solve any possibly conflicting situations.

There is thus a need for a distributed data storage solution that achieves high flexibility of use, allowing synchronizing with any device participating in the share community and operating in an automatic manner without user intervention.

### 3. SUMMARY OF THE INVENTION

The present invention aims at alleviating some of the inconveniences of prior art.

In order to optimize a distributed data storage system, the invention proposes a method of storing data shared between devices connected in a network, comprising the following steps executed by each of the devices: storing of a local copy of the shared data; storing of local history data of modifications made to the local copy of the shared data as a list of elements, referred to as nodes, each node representing a state of modification of the local copy, each node comprising: a version identifier, a list of file name and file hash pairs of files that are part of the shared data, a type information indicating if the node results from an update operation on the local copy or if the node results from a merge operation between the local copy and another local copy stored by another of the devices, and at least one link to an ancestor node.

According to a variant embodiment of the method, for creation of a version identifier of a first node of the local history data, the version identifier is a string of characters, generated through hashing of a concatenated list of hashed tuples of filename and hashed file content of files in the local copy of shared data.

This can be more formally expressed as:

hash [f1, . . . , fn]
where f1 to fn are hashed tuples of filename, hashed file contents:
hash[filename, hash (contents of file)]
for files i to n of files in the local copy.

According to a variant embodiment, a base type node is created in the local history data if an update is made to one of the files in the local copy of shared data, and wherein a merge type node is created if the local copy is synchronized with another local copy stored by another of the devices.

Two types of changes can occur to the local copy: either a change due to a local change in the files of the local copy (“update”), or a change due to a synchronization of the local copy with another local copy of another device (“merge”).

According to a variant embodiment of the method, upon an update, a new version identifier for the created update type node is created by hashing of a concatenated list, the concatenated list comprising a list of version identifiers of ancestor nodes and a list of the hashed tuples.

This can be formally expressed as:

Vx=hash(V1, . . . , Vn, f1, . . . , fn)
Where Vx is the version identifier to determine for the created update type node, V1 to Vn are version identifiers of ancestor nodes of the created update type node, and f1 to fn, hashed tuples of filename, hashed file contents for each file f1 to fn in the latest version of the local copy.

According to a variant embodiment of the method, upon a merge, resulting from a synchronization between two devices, a new version identifier for the created merge type node is created by hashing of a concatenated list, comprising a sorted list of version identifiers of ancestor nodes of type update from both local history data and history data from another of the devices with which is synchronized, and a sorted list of the hashed tuples from both the local copy and another local copy from the device with which is synchronized.

This can be formally expressed as:

Vx=hash(V1, . . . , Vn, f1, . . . , fn)
Where Vx is the version identifier to determine for the created merge type node, V1 . . . Vn are the version identifiers of its ancestor nodes of type update from both the local history data and from the history data of the other device with which a synchronization is done, and f1, . . . fn are the hashed tuples of filename, hashed file contents for each file f1 to fn in the new version of the local copy, the new version being the result of the synchronization operation.

The invention also comprises a method of synchronization for use in a distributed storage system as previously described, the method comprising the steps, implemented by a local device initiating the synchronization with a remote device, of:

a) the local device computes a local version identifier of its first local version of shared data and requests a current remote version identifier of the remote version of the shared data from the remote device;

b) if the remote version identifier is different than the local version identifier and the remote version identifier is not known in local history data, the local device requests remote history data from the remote device; otherwise, the method is finished;

c) determination, from a comparison of local and remote history data, of the operations in terms of file deletes and adds applied since common ancestors that resulted in the difference between said local and remote versions of said shared data;

d) transfer of files to the local device that must be added to the local device and delete of files from the local device, according to the previous determination, leading to a new local state of shared data;

e) merging the remote history data with the local history data;

f) if the new local version of shared data differs from both first local version of shared data and remote version of shared data, addition of a new node to the local history data comprising characteristics of the new local state.

The invention further comprises a device that implements the previous discussed method of storing shared data.

### 4. LIST OF FIGURES

More advantages of the invention will appear through the description of particular, non-restricting embodiments of the invention.

The embodiments will be described with reference to the following figures:

FIGS. 1a-d show several different network environments where the invention can be used.

FIG. 2 shows a graph type representation of version history data used by the invention.

FIG. 3 shows an example history graph for a device.

FIGS. 4 and 5 illustrate the merging of histories that is part of the method of synchronization of the invention.

FIG. 6 illustrates, with the help of a history graph, the orphaning of a history node.

FIG. 7 shows a device 700 that can be used in a system that implements the methods of the invention.

FIG. 8 is a method of synchronization according to the invention in flow chart form.

FIG. 9 is a method of storing according to the invention in flow chart form.

### 5. DETAILED DESCRIPTION OF THE INVENTION

The invention proposes a solution to sharing of data in a community of devices which will further be referred to as ‘Bitbox’. Bitbox is a decentralized file sharing system that offers distributed storage (the share′) and automatic file system synchronization. It thus ensures the automatic synchronization of a shared file folder that is replicated on different devices. Among others, it has the following properties:
it offers a synchronization mechanism that can handle any arbitrary network topology. For example, local portable or mobile devices connected in a LAN (Local Area Network) can synchronize fast with the share using their connection with the local LAN gateway or proxy at LAN speed. This allows these devices to reduce their power consumption as they can quickly return to a standby state, instead of having to perform a slow synchronization with the share over the WAN (Wide Area Network). This is possible since any device of the sharing community can synchronize with any other device of the sharing community. The local portable or mobile device can synchronize with the local LAN gateway or proxy that is part of the community, and the latter can synchronize with the other devices that are part of the sharing community. Moreover, Bitbox allows the network topology to change frequently: a device that is mobile can synchronize with the nearest device at hand that is part of the community. Finally, a set of devices of the sharing community can synchronize with each other even if they are not directly connected to the rest of the sharing community.
modifications to the share executed by any device of the community are replicated to all other devices of the community. Conflicting updates are merged silently in a safe way (i.e., no data is ever lost).

As a consequence, the Bitbox system ensures that a common file system version (i.e. ‘the share’) is available to everyone, avoiding any incoherence. This results in a system where the storage location of a file has no importance; whichever device of the community adds, removes or modifies a file in the share, the modification is ‘seen’ by all other devices of the community. In contrast with other distributed storage systems however, each device participating in the community has its own copy of the share, which allows mobile devices for example, to work offline. A variant embodiment where not all content is copied will be discussed briefly further on.
Synchronization is done in an efficient way, leveraging both the common portion of files between versions and the distributed nature of the system (i.e., synchronizing preferably against the closest devices and possibly in parallel with several devices).
Possibility to present the user with a simple interface and perform synchronize operations silently.

Prior art solutions only manage a fixed network topology and use direct synchronization to a central server like in DropBox, Unison; or are dedicated to uni-directional synchronization (backup only in e.g. Wuala, Rsync). Distributed version control systems exist (e.g., Git, Mercurial) but these systems are designed for software development and to manage source code files: they keep a full history of the file system state and rely on the user to handle conflicting updates. In the case of Bitbox, it is not considered useful or even wished to keep full history of the file system state since the solution of the invention targets a consumer electronics environment where huge multimedia files are manipulated and in which environment it is unacceptable to expect that the user solves synchronization conflicts manually. AFS, Coda, Intermezzo aim at offering “offline” features for networked file systems. These systems rely on a central server that can serialize modifications. Bitbox offers similar offline features without requiring a central coordination server and its synchronization method can be easily deployed across a wide range of platforms. For managing software development, distributed version control (e.g., Git, Mercurial) replaced traditional central version control (e.g., SVN, CVS) in numerous software development projects. However, these systems do not solve the problems solved by the current invention. For example, conflicting updates must be merged manually, and these systems maintain a whole history for all files. Bitbox aims at storing large binary (multimedia) files and offers an automatic and safe conflict resolution mechanism. Bittorrent and other P2P (peer-to-peer) related file sharing systems are mainly read-only and oriented towards single files or bundle of files. These are file exchange protocols, which do not comprise version control.

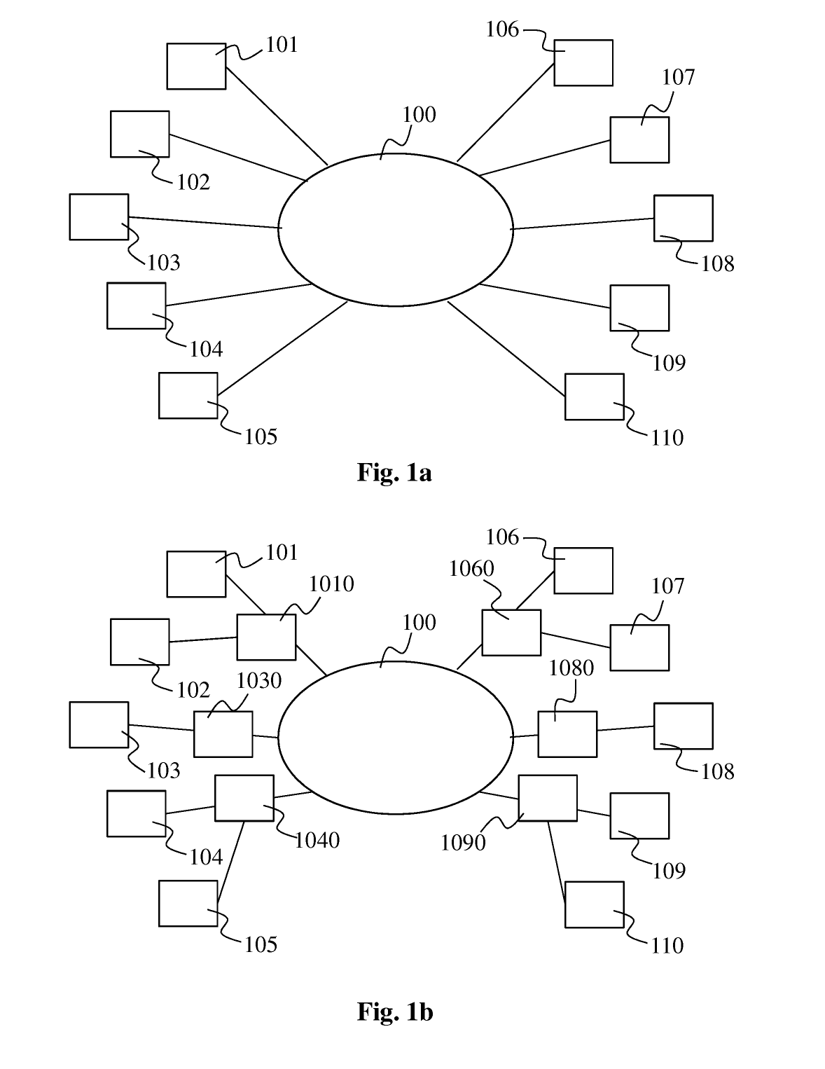

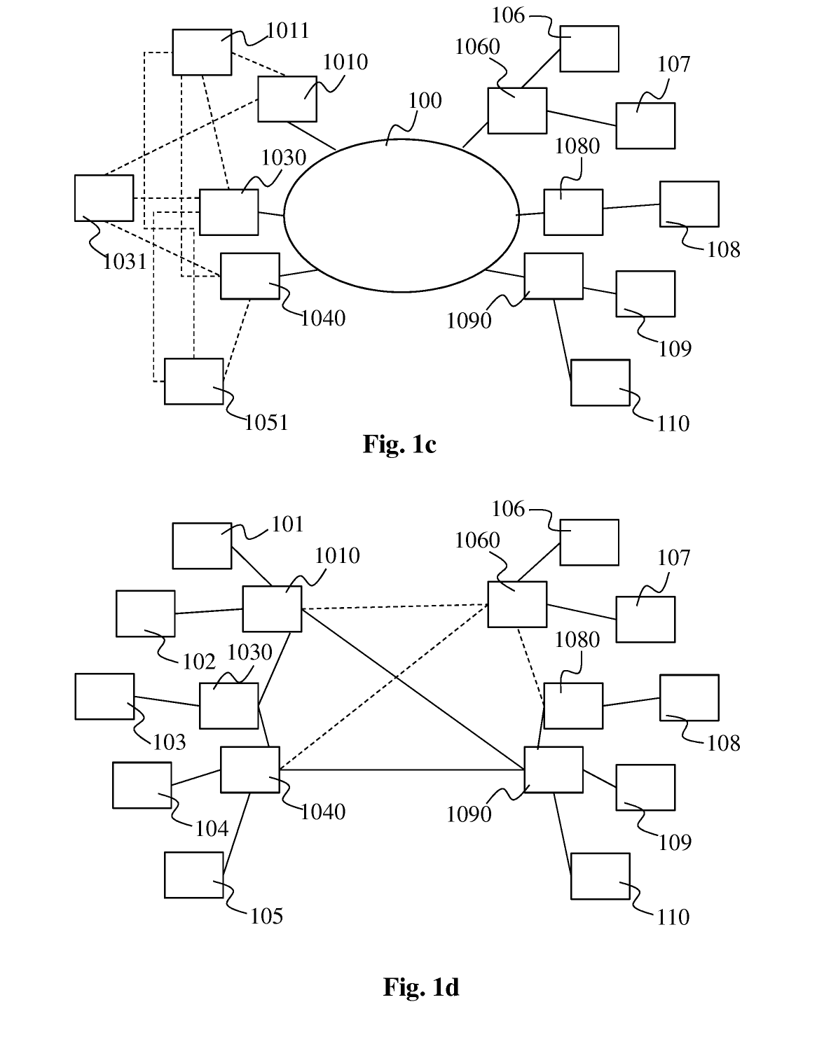

The Bitbox system makes no assumption about the network topology of the devices that are part of the share community. For example, as is depicted in FIG. 1, Bitbox is adapted to (a) a regular centralized system, (b) an hierarchical system, (c) a system that supports disconnected operations and mobile devices, or even (d) a pure server-less system. In particular, the invention allows offering efficient gateway assisted synchronization. In a gateway assisted system, the gateway is used as an active point in the network leveraging both its good connectivity to the LAN and the fact that the gateway is an “always on” device to offer a better user experience. Indeed, for mobiles devices that are battery-powered, the slow link to the Internet cloud is penalizing. By synchronizing via the LAN with the gateway, the mobile device takes advantage of the high LAN speed to synchronize in a short delay, whereas the always on gateway can synchronize via the slow Internet connection in the background.

FIG. 1a depicts a classical centralized network with a cloud 100, the network cloud representing for example the Internet or an enterprise WAN; and wired devices 101-110 that are directly connected to the cloud. The cloud represents a central point of control, which can be composed of one single physical server or of several servers tightly synchronized with a frontend and a backend, but the server(s) remain a single point of control, i.e. this is a ‘centralized’ network.

FIG. 1b depicts a gateway assisted centralized network with cloud 100 and devices 101-110, but in contrast with FIG. 1a, the devices 101-110 are connected to the cloud via gateways 1010, 1030, 1040, 1060, 1080 and 1090. Devices 101 and 102 are connected to gateway 1010, and these devices are thus connected in a sub network, i.e. a LAN. This configuration is typical for a home network for example, in which the LAN proposes a high speed local communication network via the gateway, and the gateway further offers the devices of the home network access to the Internet or WAN. The same goes for device 103 and gateway 1030, devices 104 and 105 and gateway 1040, devices 106, 107 and gateway 1060, device 108 and gateway 1080, and devices 109, 110 and gateway 1090.

FIG. 1c depicts a gateway assisted centralized network with mobile devices that are not permanently connected to a gateway, which is illustrated by dotted lines. Each of the mobile devices 1011, 1031 and 1051 can connect to any of the gateways 1010, 1030 and 1040, for example to the nearest one; a gateway at home, at work or at a friend's premises.

FIG. 1d depicts a gateway assisted decentralized P2P network, with a part (illustrated by dotted lines) that can be disconnected. An advantage of the current invention is that it supports disconnected operation, so each device that is part of the share community can use the share even when the device is not connected to the other devices of the share via the central network that interconnects all devices; even two devices not connected to the central network but connected to each other can synchronize between them and join the central network later.

In order to achieve the advantages of the invention, devices that use the Bitbox system are organized around a same share, e.g. a shared file system, they are ‘member’ of what we will refer to as a same ‘share community’. Of course, devices using the Bitbox system may be member of different share communities. Each device maintains history data of the various states of its local copy of the share. This history data can be represented as a linked list of nodes, which can be stored in a data base, in memory, or in a file. Each node of the linked list thus represents a particular state of the local copy of the share. One of the nodes is marked as being the latest version. Each node comprises a list of pairs (file name, file hash) (a “hash” a unique identifier that is obtained through a mathematical operation applied to a file (also called “hashing”, such as SHA256), and the node further comprises the type of operation that resulted in creation of the node (BASE or MERGE), a version number, and one or more link(s) to its predecessor(s). The history is said to be ‘compact’, since it does not comprise any full files that are stored in the share, nor does it comprise any deltas (i.e. files containing only the differences between two versions of a file). In the following, we will use the wording ‘local’ and ‘remote’, for ‘local’ device and ‘remote’ device and ‘local’ history and ‘remote’ history. The ‘local’ device is the device initiating the synchronization action with a ‘remote’ device. The wording ‘local’ history is used for the history data detained by the device that takes the initiative to synchronize, and ‘remote’ history will be used for the history data that is detained by the device with which it synchronizes. For simplicity of implementation, the synchronization is described as a unidirectional operation. Bidirectional operation is also possible, for example through triggering of a synchronization of the ‘remote’ device when the ‘local’ device initiates a synchronization. This does not change the features of the invention, it merely results in the two devices executing the synchronization operation simultaneously. In the following, we only consider the ‘import’ of modifications to the share by the remote device. The described invention however also supports an ‘export’ of modifications made to the share by the local device to the remote device, or simultaneous ‘import/export’.

Synchronization with the other copies of the share stored by the other devices that are part of the same share community occurs periodically, i.e. on a fixed-delay basis, or when changes occur, or when a device decides to synchronize (for example, upon connection of a mobile device to a gateway that is part of the share community). All of these variant embodiments can be advantageously combined. When synchronization occurs:

1) the device initiating the synchronization (=“local device”) computes its current version number (=“own” version number) and requests the current version number (the version number calculation method is particular to the invention and will be discussed later in detail) from any one of the share community devices to which it is connected (=“requested” version number, and “remote” device); According to a variant embodiment, the sharing community device from which the local device requests the current version number is deliberately chosen, for example a home network device deliberately chooses the home gateway, because the chance that the gateway has synchronized recently is greater than the chance that any of the devices connected to the gateway synchronized, since many home network devices are connected to the gateway.

2) if the requested version number is different than the own version number and is not known in the local history data (i.e., is not an “old” version), further processing is needed. If further processing is needed, steps 3-5 are executed. If not, the synchronization is done.

3) The local device requests the history from the remote device. From the comparison of the local and the remote history data, it is determined what were the operations in terms of delete/add operations that resulted in the difference. This is done to be able to import the necessary files from the remote device to the local device and thus have both devices synchronized with each other. The determination of the operations comprises a search for common ancestors (in terms of nodes with a same version number) between local and remote history data (this search will be discussed later in further detail). Then, starting from the common ancestors, and for each of the local and remote history data, changes are determined between the common ancestors and the current local and remote versions. These changes are characterized in terms of add or delete: ADD (file name, file hash) or DEL (file name, file hash). Other types of modifications such as file rename or file modification are still expressed in terms of add and delete operations. In case of conflicting changes, e.g. ADD (file name 1, file hash X) and ADD (file name 2, file hash X) i.e. a same file was added both on the remote share and on the local share, but under different file names, an automatic and safe merge is performed.

4) the above determination step 3 results in a list of files that must be downloaded from the remote device to the local device, and/or files that must be deleted from the local device, and/or files that must be renamed or copied from local file. Whenever file download is necessary, the concerned file(s) can be obtained by direct file download, or using a delta-based transfer protocol (e.g., rsync) or, according to an advantageous variant embodiment, with a P2P file exchange protocol, which is particularly suited for a distributed environment as in the current invention. According to the latter a device (local or remote) that needs a file subscribes to the file which is identified by its hash. The subscriber then downloads parts of the file from devices that have these parts (source devices). File parts are downloaded in parallel from different source devices and the subscriber can provide downloaded file parts to other devices that request it. Fully downloaded files i.e. of which all parts have been received, are added to the local share. Files that must be deleted (i.e. not present in the remote share) are deleted from the local share.

5) once the add/delete operations have been completed, the synchronization operation is completed by merging the history data.

More details with regard to the above described synchronization method of the invention are given in what follows.

Version numbers have a global scope, i.e. they are not relative to a particular device that has a local version of a share, but relative to all devices members of the sharing community. The method of determining a version number is thus the same for each device. The method of determining a version number is such that different add/delete operations done by a user on a local or remote device, that give a same result in terms of share content, will result in an identical version number. According to the method of determining a version number, automatic merge operations (i.e. new versions resulting from a merge with no user add/delete) will result in a unique version number whatever the order of the merges.

On the other hand, different modifications done by any user of identical local copies of the share will result in different version numbers. When a hash function is used to generate the version number, version numbers have a high probability to be unique if the content over which the hash function is applied is unique. The probability also depends on the type of hash function used.

An example method to calculate a new version number according to the previous characteristics of the version number is given hereunder in pseudo code. The version number depends on both the content and the previous version, yet MERGE type versions and merge order are ignored.

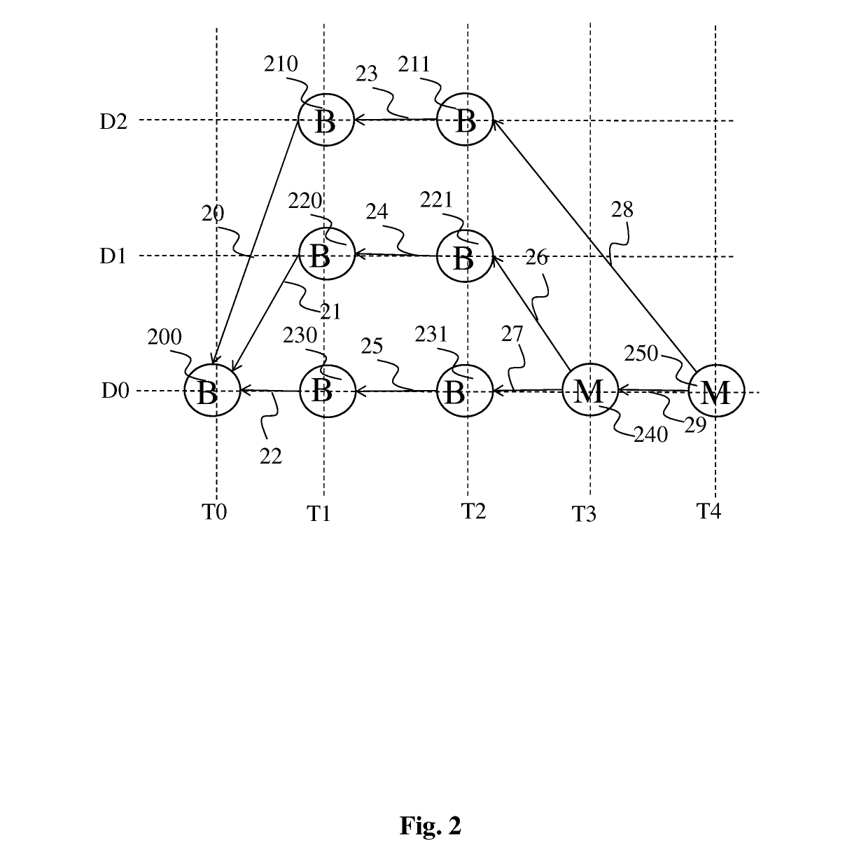

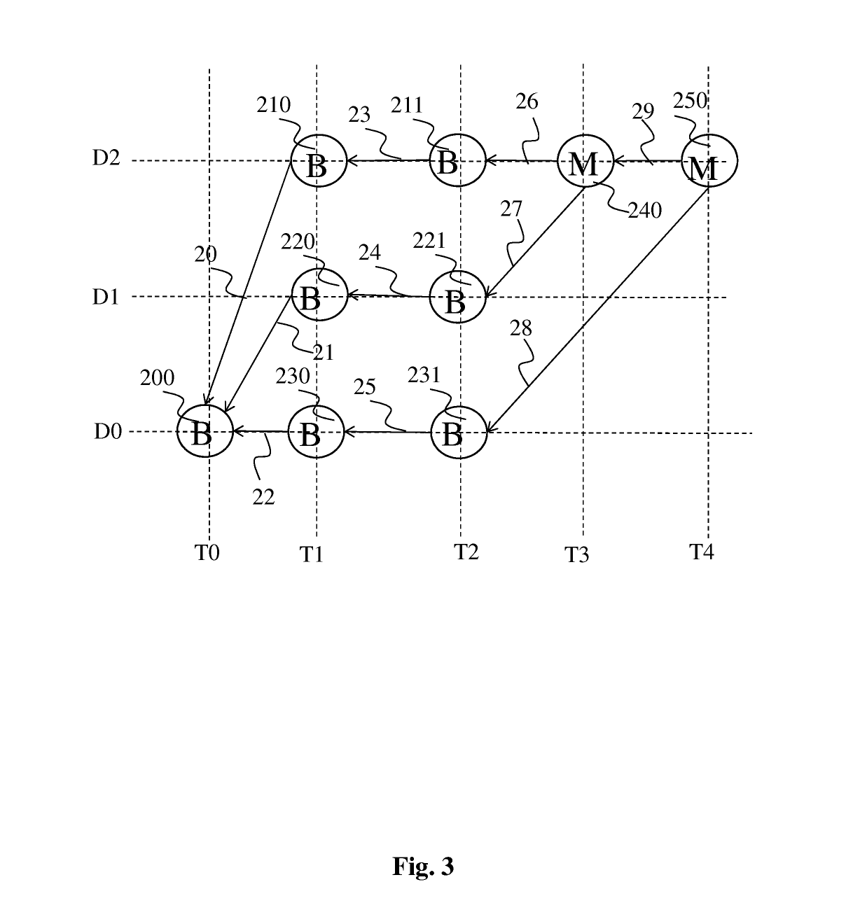

A consequence of these design choice is that 250 in FIGS. 2 and 3 have the same version number even if merges were performed in a different order.

Algorithm 1. Computing versions.

Enum NODETYPE { TYPEBASENODE, TYPEMERGENODE }
CLASS FILESPEC

String name
String hash

End class FILESPEC
CLASS NODE

FILESPEC [ ] filelist
NODETYPE nodetype
String version
NODE [ ] predecessorlist

End class NODE
This function returns the BASE type ancestor of a node
1: NODE BASE_ANCESTORS (NODE a)

| | |
|---|---|
| 2: | if a.nodetype is TYPEBASENODE then |

| | |
|---|---|
| 3: | return a |

| | |
|---|---|
| 4: | else |

| | |
|---|---|
| 5: | return ∪ᵢ∈PARENTS(a) BASE_ANCESTOR (i) |

| | |
|---|---|
| 6: | end if |

```
  7: end
This function returns a new node comprising a new version
number resulting from a merge of two versions a and b
represented by two nodes a1 and a2. The Content parameter
passed is the result of the function FILES-AND-HASHES,
that retrieves filenames and associated hashes for
content on the local share
  8: NODE MERGE (NODE a₁, NODE a₂, FILESPEC[ ] content)
```

| | |
|---|---|
| 9: | // look for the most recent ancestor of type BASE |

for both nodes

| | |
|---|---|
| | ancestors = BASE_ANCESTORS (a₁) ∪ BASE_ANCESTORS (a₂) |
| 11: | // sort ancestors and and concatenate with sorted |

content

| | |
|---|---|
| 12: | INT version = SHA256(sorted(ancestors).sorted(content)) |

| | |
|---|---|
| 13: | return new NODE(content, |

TYPEMERGENODE,version,LIST(a,b))

14: end
This method generates a new version number resulting from a
change on the local file system after version a
15: NODE UPDATE(NODE a, FILESPEC[ ] content)

| | |
|---|---|
| 16: | ancestors = BASE_ANCESTOR (a) |

17:

| | |
|---|---|
| 18: | INT version = SHA256(sorted(ancestors).sorted(content)) |

| | |
|---|---|
| 19: | return new NODE(content, TYPEBASENODE,version,LIST(a)) |

| | |
|---|---|
| 20: | end |

Class NODE comprises a list of files that is comprised in the local copy of the share. The list of files comprises for each file a filename and a hash, that is computed over the content of the file with for example a hash function such as SHA256.

Method BASE_ANCESTORS takes a node as an argument. It parses a local history and returns the BASE type ancestor nodes of the node that is passed as an argument. This method goes through the history data from the node passed as argument to its parent and applies recursively until it finds ancestors of type BASE.

Method MERGE takes two nodes as an argument. It generates a new (MERGE type) node with a new version number. This method is to be used when a new node is to be created that is the result of a synchronization operation.

Method UPDATE takes a node and a file as arguments. It generates a new (BASE type) node with a new version. This method is to be used when a new node is to be created that is the result of a local modification of a local copy of the share.

As mentioned, two types of versions exist, BASE or MERGE. A BASE version number type of a node is the result of a local modification to the share, whereas a MERGE version number type of a node is a new state of the share resulting from a synchronization operation.

The local history data related to a share can be represented as a linked list as has been previously discussed. Other implementations are possible according to the invention, such as an arraylist, a hashmap or RBtree for example. This history data can be illustrated as a directed acyclic graph, with the last node representing the current version of the share. In such a graph, BASE versions have only one immediate predecessor (or ‘parent’), while MERGE versions have two immediate predecessors (or ‘parents’). Each MERGE version of the share has a set of latest BASE ancestors. In the history data, BASE ancestors of a MERGE version are found by parsing the history data (i.e. following the above discussed links) and moving upwards, until two BASE type nodes are found. A graph type representation of the history data as stored in a single device (for example: D0) is illustrated in FIG. 2. The graph is read from the left to the right. Time scale is illustrated horizontally (T0-T4) and device scale is illustrated vertically (D0-D3). Circles represent nodes, i.e. share versions, and arrows or “edges” represent links. Node numbers is this version number. ‘B’ marked nodes are BASE type nodes, and ‘M’ marked nodes are MERGE type nodes. At T0, there was only one version of the share, i.e. resulting in a creation of node 200. At T1, there were three versions of the share; one (230) issued from modifications of share 200 by device D0, another issued from modifications of share 200 by device D1, and yet another issued from modifications of share 200 by device D2. At T2, each of the devices further modified their copy of the share, resulting in a creation of node 231 that contains the characteristics of the share detained by device D0 at T2, a version 221 detained by device D1, and a version 211 detained by device D2. At T3, device D0 has synchronized with device D1. This results in creation of node 240. At T4, device D0 has synchronized with device D2, resulting in creation of node 250.

Let us now consider an example history graph for device D2 in FIG. 3. Here, node 240 is the result of a merge operation at T3 between D2 and D1, and node 250 is the result of a merge operation at T4 between D2 and D0.

As can be observed, between FIGS. 2 and 3, even if the synchronize operations executed by D0, D1 and D2 are done in a different order, the resulting states of the shares are the same, i.e. node 250.

FIG. 2 is also used for illustration how a new version “number” is calculated, for example for node 250 using for example previously mentioned function “SHA256” mentioned in pseudo-code Algorithm 1. According to the described embodiment, the version is indeed not a number, but rather a string of characters, as for example obtained by a SHA256 function (e.g. thus obtaining a string of 64 characters). In the first place, ancestors of node 250 of type BASE are searched, using for example Algorithm 1's function “BASE_ANCESTORS”. This results in nodes 211, 221, and 231. Their version ‘numbers’ are retrieved, i.e. thus obtaining three strings of characters. These strings are then ordered in alphabetical order, and concatenated, giving a concatenated version number string of 3*64 characters. Independently, the list of files currently in the local copy of the share of device D0 is retrieved (for example, by scanning of the disk of device D0). For each file, the hash is calculated. This scan and hash calculation can be done using a permanently running indexation function, that comes into action each time a file is added or modified to the local copy of the share, which results are then stored on the device, thus avoiding the need to execute a CPU and time-consuming scan and hash calculation over all files. The lists of resulting hashes (one for each file in the local copy of the share) is put in alphabetical order, and the resulting sorted file hash strings are concatenated as one string. Finally, the concatenated file number string and the concatenated file hash string are concatenated in turn, and a hash string is calculated over the resulting string, which results in a new version “number”.

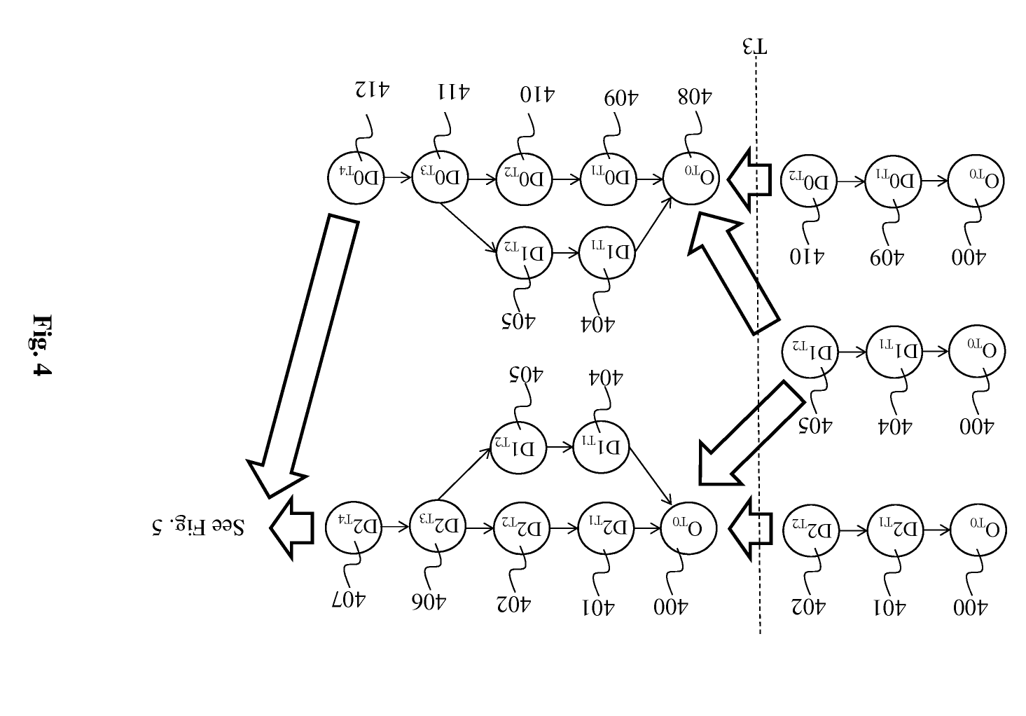

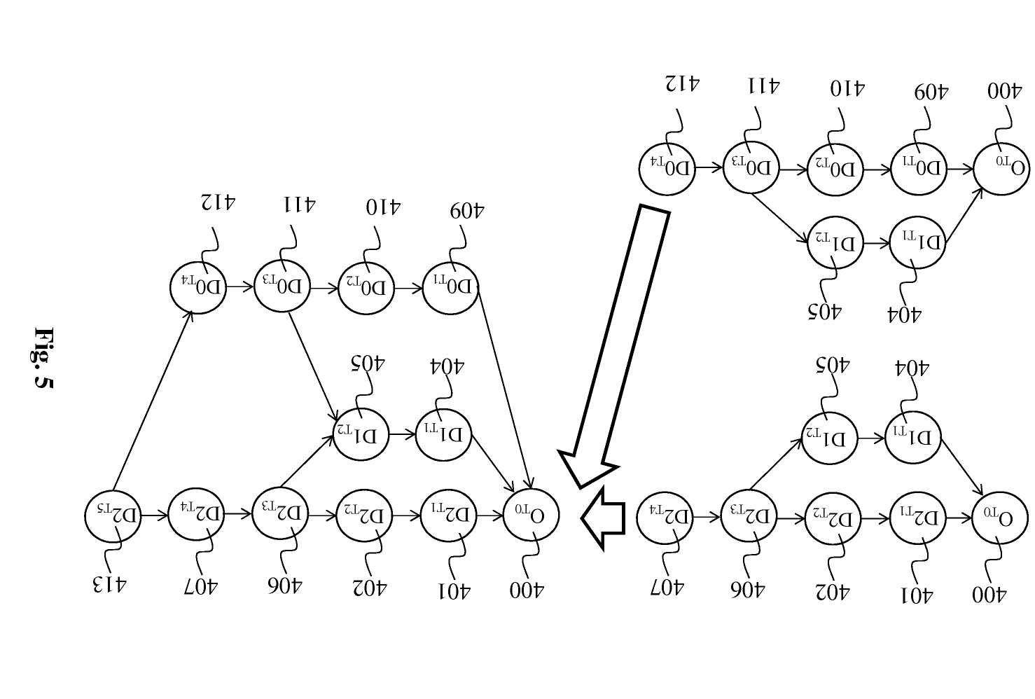

FIGS. 4 and 5 illustrate the merging of histories that is part of the method of synchronization of the invention (e.g. previous discussed step 5). Illustrated in FIG. 4 are the local history for each of three devices D0-D2. Again, reference numbers illustrate version numbers, which are also referred to as ‘nodes’ in the device history. At T0, each device history comprises a BASE type node with version number 400 marked O_{T0} for Original at T0. At T1 and T2, the local versions of the share are modified i.e. for D2, resulting in a new BASE type node with version number 401 at T1, and BASE type node with version number 402 at T2, and similarly for other devices D1 and D0, resulting in respectively BASE type nodes with version numbers 404 at T1 and 405 at T2 for D1, and 409 at T1 and 410 at T2 for D0. Then, at T3, device D2 synchronizes with device D1, and device D0 also synchronizes with device D1. This results in, for device D2, a new MERGE type node with version number 406, and for device D0, a new MERGE type node with version number 411. At T4, both versions of D2 and D0 evolve to a modified version, i.e. version 407 for D2, and version 412 for D0. Now referring to FIG. 5, device D2 synchronizes at T5 with device D0. This results in the history graph on device D2 as depicted, with the creation of a new node of type MERGE with version number 413.

FIGS. 4 and 5 are also referred to illustrate the process of determining which changes must be applied to the local copy of the share that is part of the synchronization method of the invention (as in previously discussed step 3). As can be seen in FIG. 4, when at T3 device D2 synchronizes with device D1, D2 retrieves the history data from D1. From D2's and D1's history data it can be determined that version 400 is the common ancestor to versions 402 and 405, and that the D1's versions 404 and 405 are thus modifications of this common ancestor version 400. An example method for searching of common ancestors in two sets of history data is given hereunder in pseudo code.

Algorithm 2. Finding differences.

version_{Local} is the current local version.
version_{Remote} is the current remote version.
HISTO is a linked list of NODE.
Method CONTENT(String v) returns the set of filespecs (name,
hash) of a version v, identified by its version number.
This is an internal function, used for the computation of
common ancestors. It parses through two history trees until a
set of ancestors common to the two histories is found.
1: NODE[ ] INC_ANCESTORS(String version, HISTO H_{local}, HISTO
Hᵣₑₘₒₜₑ)

| | |
|---|---|
| 2: | if version ∈ Hᵣₑₘₒₜₑ then |

| | |
|---|---|
| 3: | return version |

| | |
|---|---|
| 4: | else |

| | |
|---|---|
| 5: | return∪ _{i∈PARENTS(}H_{local, version)} INC_ANCESTORS(i_{X}, H_{local}, Hᵣₑₘₒₜₑ) |

| | |
|---|---|
| 6: | end if |

```
  7: end
This function returns the common ancestors of two given
versions, between two sets of history data
  8: NODE[ ] COMMON_ANCESTORS(String version_{Local}, String
versionᵣₑₘₒₜₑ, HISTO H_{local}, HISTO Hᵣₑₘₒₜₑ)
```

| | |
|---|---|
| 9: | return INC_ANCESTORS(version_{Local}, H_{local}, Hᵣₑₘₒₜₑ) ∪ |

INC_ANCESTOR(versionᵣₑₘₒₜₑ, Hᵣₑₘₒₜₑ, H_{local})

10: end
This function finds the operations in terms of add or delete
that are the cause of a difference between two versions from
two sets history data
11: (FILESPEC [ ],FILESPEC[ ]) DIFF(String version_{Local}, String
versionᵣₑₘₒₜₑ, HISTO H_{local}, HISTO Hᵣₑₘₒₜₑ)

| | |
|---|---|
| 12: | NODE [ ] ancestors = COMMON_ANCESTORS(version_{Local}, |

versionᵣₑₘₒₜₑ, H_{local}, Hᵣₑₘₒₜₑ)

| | |
|---|---|
| 13: | for each a of ancestors |

| | |
|---|---|
| 14: | Add_{local} = Add_{local} + |

(CONTENT(version_{Local}) − CONTENT (a))

| | |
|---|---|
| 15: | Del_{local} = Del_{local} + |

(CONTENT(a) − CONTENT(version_{Local}))

| | |
|---|---|
| 16: | Addᵣₑₘₒₜₑ = Addᵣₑₘₒₜₑ + |

(CONTENT(version_{Remote}) − CONTENT(a))

| | |
|---|---|
| 17: | Del_{local} = Del_{local} + |

(CONTENT(a) − CONTENT(version_{Remote}))

| | |
|---|---|
| 18: | end for |
| 19: | FILESPEC[ ] Del = Delᵣₑₘₒₜₑ − Del_{local} |
| 20: | FILESPEC[ ] Add = Addᵣₑₘₒₜₑ − Add_{local} |
| 21: | return (Del,Add) |

22:end

Function COMMON_ANCESTOR(s) returns the common ancestors of two given versions, which are common between two sets of history data.

Function DIFF returns a list of files that must be added and/or deleted.

So, in order to include in the local share detained by D2 the modifications done by D1, in the first place, latest local version 402 is compared to common ancestor version 400 to determine what local changes were applied to common ancestor version 400 (in terms of add files, delete files); then, the same is done for remote version 405 and common ancestor version 400 to determine what remote changes were applied to common ancestor version 400 in terms of add files, delete files, and finally this knowledge of what has changed locally and remote with reference to the common ancestor version 400 is used to determine what files must be retrieved from D1 and what files must be deleted from D2. This results in a new version of the local copy of the share on D2 and in creation of a version 406.

According to the above described embodiment, every device has the same priority to modify files of the share. I.e. if a device (e.g. A) adds a file to its local copy of the share, the file will also be added to the local copy of the share of another device (e.g. B) of the share community if B synchronizes with A. Subsequently, when another device (e.g. C) synchronizes with B, C will also add the file added by A to its local copy of the share. Likewise, a delete of a file that is shared by the other devices of the community done by any of the devices of the share community will also be deleted from the local copy of the share of another device when the latter synchronizes with the first. Changes are thus propagated progressively through the local copies of the share as devices synchronize with each other.

According to the above described embodiment, synchronization between devices is unidirectional, i.e. when device A synchronizes with device B, only A updates its local copy of the share as a function of the modifications to the share done by B. The update of B with the modifications done by A is done with a separate synchronization action, i.e. when B synchronizes with A. This ‘unidirectional sync’ embodiment has the advantage that the protocol of synchronization is kept straight forward for users; it is device that connects to another (the ‘local’ device that connects to the ‘remote’ device) that takes the initiative to synchronize, it is thus the local device that integrates the changes occurred on the remote device. For the remote device this does result in any modification to its copy of the share, since no changes are made to its copy of the share as the remote device did not taken any initiative to do any synchronize operation. From a point of view of data security, this solution might be preferred because it is easier for a user to obtain an authorization to modify data on the ‘own’ device than to obtain authorization to modify data on another device. Also, the duration of the synchronization operation is kept short as well as the number of messages and the amount of data exchanged between the two devices is reduced. Alternatively, according to a variant embodiment, synchronization between devices is bidirectional, i.e. when device A contacts B for synchronization, both devices exchange their modifications. Though the previous mentioned observations are valid for this variant, the advantage of this embodiment is that modifications are faster propagated through the sharing community, which avoids the different versions to diverge, avoids longer synchronization operations and reduces the probability of occurrence of synchronization conflicts.

The pseudo code hereunder gives an example of how to apply the differences (as in previously discussed step 4) that are previously determined (see algorithm 2 and step 3) for the synchronization.

Algorithm 3. Applying the differences observed.

FILES_AND_HASHES returns a list of filename, file hash pairs
of the files that are currently on the local copy of the share
1: SYNCHRONIZE(int version_{Local},version_{Remote},H_{Local},H_{Remote})

| | |
|---|---|
| 2: | // Get the list of files to add and/or to delete |
| 3: | (Del,Add) = DIFF(version_{Local},version_{Remote},H_{Local},H_{Remote}) |
| 3: | // Calculate the final list of files that we should |

obtain when changes are applied

| | |
|---|---|
| 4: | expected_content = |
| | APPLY(CONTENT(version_{Local}),Del,Add) |
| 5: | Download new content here. |
| 6: | In the following: perform the adds and deletes while |

resolving conflicts.

| | |
|---|---|
| 7: | actual_content = FILES_AND_HASHES(new downloaded |
| | content) |

| | |
|---|---|
| 18: | // Merge histo: add unknown edges and nodes to |

Hlocal

| | |
|---|---|
| 9: | H_{N} ← H_{Local} |

| | |
|---|---|
| 10: | for each n ∈ H_{Remote}.nodes −H_{Local}.nodes |

| | |
|---|---|
| 11: | H_{N} ←H_{N} + node(n) |

| | |
|---|---|
| 12: | end for |
| 13: | for each e ∈ H_{Remote}.edges −H_{Local}.edges |

| | |
|---|---|
| 14: | H_{N} ←H_{N} + edge(e) |

| | |
|---|---|
| 15: | end for |
| 16: | // check wether version written to disk is exactly |
| 17: | // the same as previous local version and if so, |
| 18: | // reuse version number. |
| 19: | if expected_content = CONTENT(a_{Local}) then |

| | |
|---|---|
| 20: | a_{N} ←a_{Local} |

| | |
|---|---|
| 21: | else if expected_content = CONTENT(a_{Remote}) then |

| | |
|---|---|
| 22: | a_{N} ←a_{Remote} |

| | |
|---|---|
| 23: | else |

| | |
|---|---|
| 24: | // version number differs, add to histo |

| | |
|---|---|
| 25: | a_{N} ←MERGE(a,b, expected_content) |
| 26: | H_{N} ←H_{N} + node(a_{N}) + edge(a_{Remote},a_{N}) + |

edge(a_{Local},a_{N})

| | |
|---|---|
| 27: | end if |
| 28: | // If changes occurred during synchro operation |
| 29: | // then add a BASE type node with the resulting |
| 30: | // state of both the changes and the merge. |
| 31: | if expected_content≠actual_content then |

| | |
|---|---|
| 32: | a_{O} ←a_{N} |
| 33: | a_{N} ←UPDATE(a_{O}, actual_content) |
| 34: | H_{N} ←H_{N} + node(a_{N}) + edge(a_{O},a_{N}) |

| 35: | end if | |
|---|---|---|
| 36: | // return update histo and current version number. | |
| 37: | return | (a_{N},H_{N}) |

38: end function

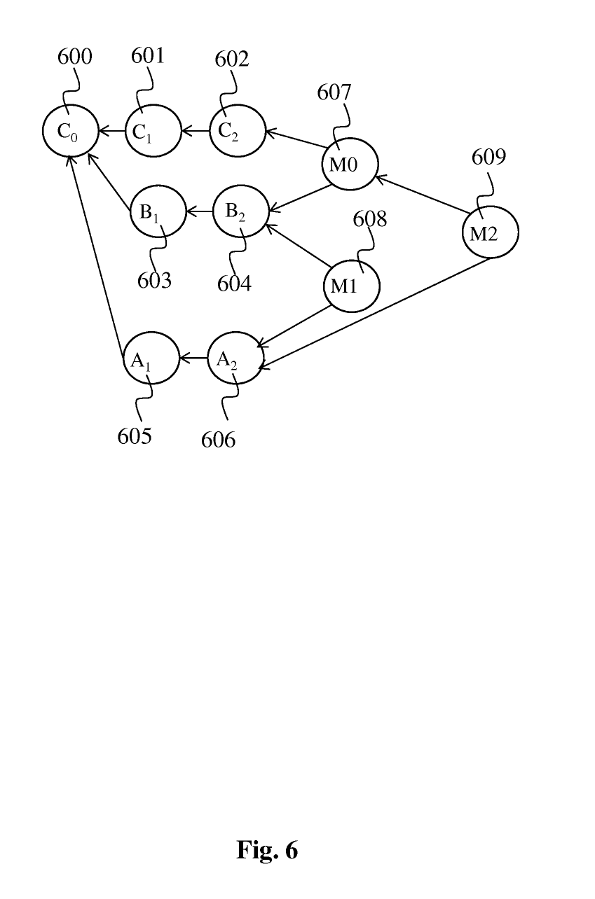

Once files have been downloaded, the actual deletion and additions of files have been performed, histories need to be merged, cf previous discussed step 5 of the synchronization method. In order to merge the histories, all unknown nodes from the remote history are added to the local history. The same applies for unknown edges. The resulting content actual_content is computed (i.e. the list of FILESPEC[ ] is obtained by scanning the contents of the local copy of the share) and if it differs from the content of both merged versions a_{local} and aᵣₑₘₒₜₑ, a new node (Merge, Merge(a_{local},aᵣₑₘₒₜₑ), content) is added to the local history. In some cases, the resulting content does not differ from the content of some existing version a or b. Indeed, if merges are performed in different order, it is possible that a version M₁ is imported but a current version M₂ already encloses the merge between BASE ancestors of M₁ that was done in a different order. In this case M₁ becomes an orphaned node and M₂ is the active node that will be used as a reference for future versions (it is also possible that M₂ is the imported version and M₁ is the local version). If local changes have occurred in between the computation of the state and the remote history being imported, these changes are saved and are considered as occurring immediately after the merge operation. The above case is illustrated in FIG. 6. If a version M1 (608) corresponding to a merge operation of B₂ (604) and A₂ (606) is imported at a device where a merge already encloses all changes having occurred in version B₂ and A₂, then M₁ is simply orphaned and M₂ (609) is marked as the latest version.

Once the changes that occurred locally (ADD_{Remote}) and remotely (ADD_{Local}) have been computed, conflicting updates can be detected. Conflicting updates are two conflicting operations on the same file name but with different hashes i.e., additions of file (filename1, hash1) on the local side and of file (filename1, hash2) on the remote side. Note that conflicting deletions are not possible, since the local deletion operates on (filename1, hash1) and the remote deletion operates on (filename1, hash1) as in the common version, file filename1 had hash hash1. Since all other operations are transformed into additions and deletions, no other cases can happen. This conflict must be solved in a safe way i.e., in a way that prevents any data loss. To this end, new names are assigned to the files. Furthermore, the assigned names depend only on the content of the file. The conflicts are saved in the history so that hidden conflicts can be detected during merge operations. For example, assuming that a conflict exists between version A, B and C; even if the rename during the merge of A and B hides the conflict during the merge of A+B and C, we must also perform the renaming on C so that the order of the merge does not influence the final resulting state. Thus the resulting state is the same as if the synchronization occurs in the order A+C and B. The hidden conflicts that need to be replayed are all conflicts saved at MERGE type nodes found in the history on the paths from the actual local and remote versions to the common ancestors. This list of hidden conflicts can be computed during the search for common ancestors.

In order to solve the conflicts detected according to the previous description, the files are renamed. One possible way to rename the file, is the following: the corresponding file of given hash is renamed from filename.ext to filename-hash.ext. The filename is updated continuously so that the hash used matches the file content, until the user solves the conflict by renaming the file manually.

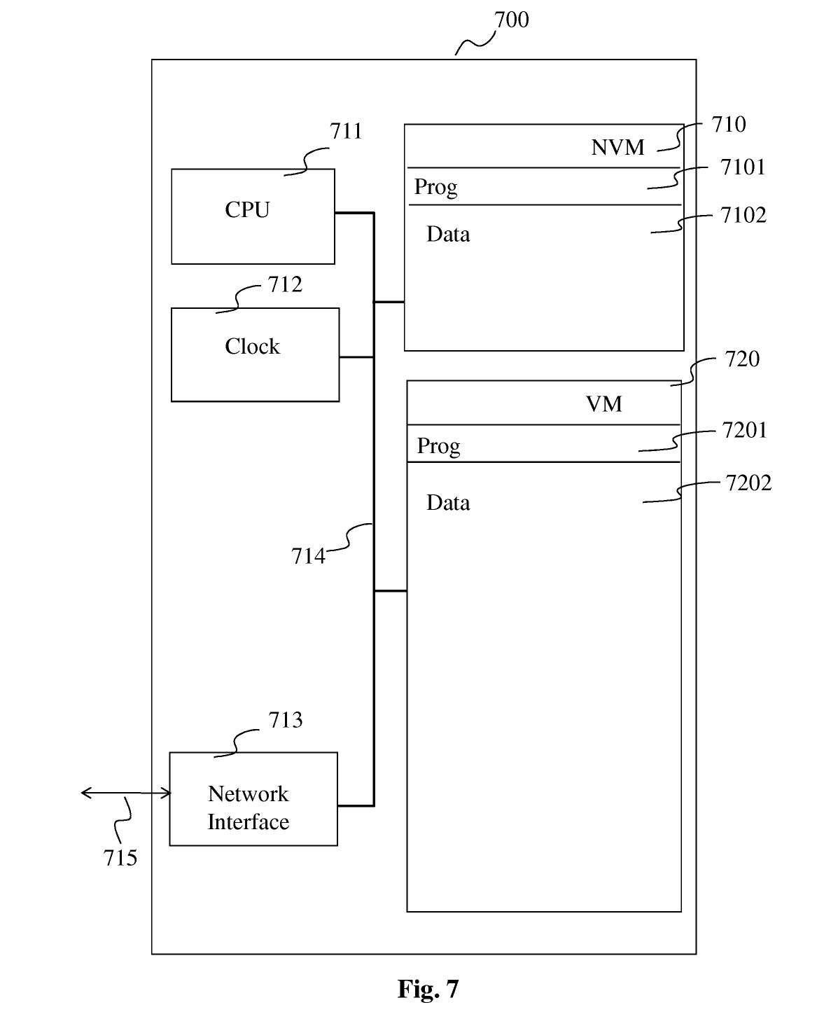

FIG. 7 shows a device 700 that can be used in a system that implements the methods of the invention. The device comprises the following components, interconnected by a digital data—and address bus 714:
a processing unit 711 (or CPU for Central Processing Unit);
a non-volatile memory NVM 710;
a volatile memory VM 720;
a clock 712, providing a reference clock signal for synchronization of operations between the components of the device 700 and for timing purposes;
a network interface 713, for interconnection of device 700 to other devices connected in a network via connection 715.

It is noted that the word “register” used in the description of memories 710 and 720 designates in each of the mentioned memories, a low-capacity memory zone capable of storing some binary data, as well as a high-capacity memory zone, capable of storing an executable program, or a whole data set.

Processing unit 711 can be implemented as a microprocessor, a custom chip, a dedicated (micro-) controller, and so on. Non-volatile memory NVM 710 can be implemented in any form of non-volatile memory, such as a hard disk, non-volatile random-access memory, EPROM (Erasable Programmable ROM), and so on.

The non-volatile memory NVM 710 comprises notably a register 7201 that holds a program representing an executable program comprising the method of exact repair according to the invention, and a register 7202 comprising persistent parameters. When powered up, the processing unit 711 loads the instructions comprised in NVM register 7101, copies them to VM register 7201, and executes them.

The VM memory 720 comprises notably:
a register 7201 comprising a copy of the program ‘prog’ of NVM register 7101;
a data storage 7202.

A device such as device 700 is suited for implementing the method of the invention of storing of data and for implementing the method of synchronization.

According to a variant embodiment, the invention is entirely implemented in hardware, for example as a dedicated component (for example as an ASIC, FPGA or VLSI) (respectively <<Application Specific Integrated Circuit>>, <<Field-Programmable Gate Array>> and <<Very Large Scale Integration>>) or as distinct electronic components integrated in a device or in a form of a mix of hardware and software.

As in previous described embodiments, a version identifier (or version ‘number’) is a character string, and the classification method is an alphabetical sort operation. According to an alternative embodiment, a version identifier is an integer number, and the classification method is a numerical sort operation.

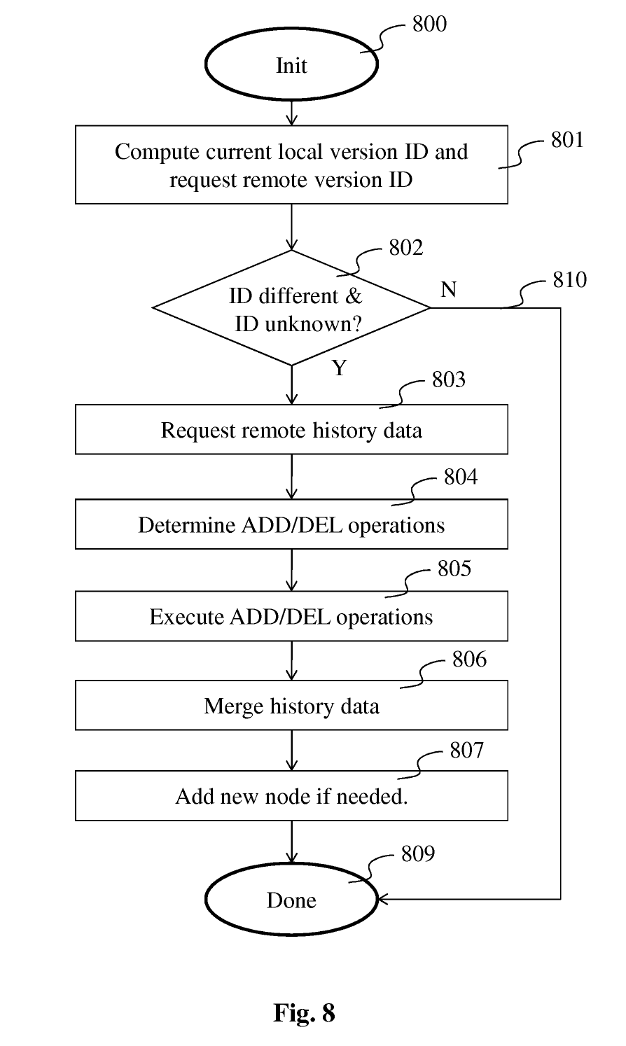

FIG. 8 shows the method of synchronization according to the invention in flow chart form.

In a first step 800, the method is initialized. This initialization comprises initialization of variables and memory space required for application of the method. In a step 801, the local device computes a local version identifier of its first local version of shared data and requests a current remote version identifier of the remote version of the shared data from the remote device. In a decisional step 802 it is determined if the remote version identifier is different than the local version identifier and the remote version identifier is not known in local history data. If so, the local device requests remote history data from the remote device in a step 803; otherwise, the method is finished, which is indicated by arrow 810 that enters step 809. After step 803, in a step 804 it is determined, from a comparison of local and remote history data, which operations in terms of file deletes and adds have been applied since common ancestors that resulted in the difference between said local and remote versions of said shared data. In a step 805, transfer of files to the local device that must be added to the local device and delete of files from the local device is done, according to the previous determination, which leads to a new local state of the shared data. In a step 806, the remote history data is merged with the local history data. In a step 807, it is determined if the new local version of shared data differs from both first local version of shared data and remote version of shared data, and if so, a new node is added to the local history data comprising characteristics of the new local state. In step 809, the synchronization is done.

According to a variant embodiment, the devices of the sharing community do not all detain a full copy of the share. In fact, though every device has its own history of modifications which comprises a file list, it can be sufficient to ensure in the sharing community that some files that are part of the local copy of the share are not stored locally but are only stored by one or more of the other devices of the sharing community, and in case that the files are to be accessed, they can be downloaded. This variant can be advantageous for example for files that have a very low access frequency on the local device.

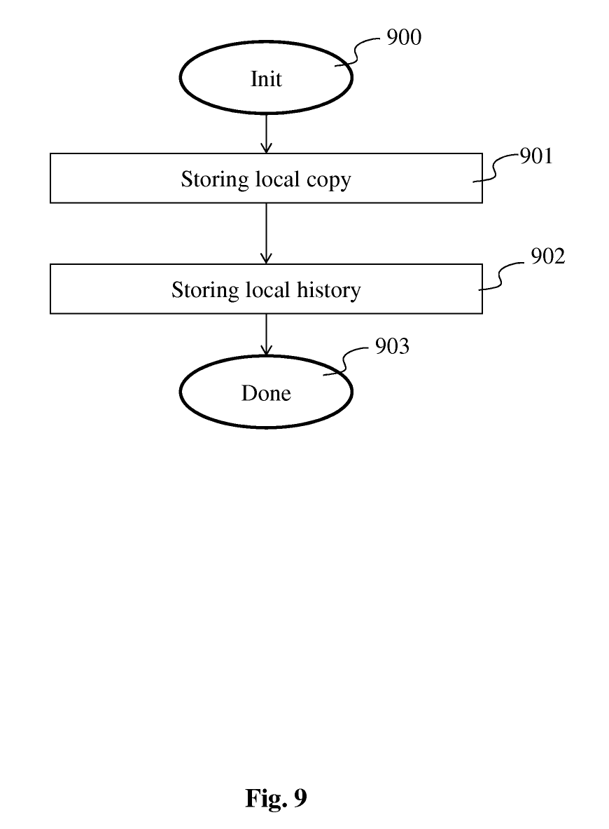

FIG. 9 is a method of storing according to the invention as implemented in one of the devices connected in a network, such as devices depicted in FIGS. 1a to 1d. In a first step 900, the method is initialized. This initialization comprises initialization of variables and memory space required for application of the method. In a step 901, a local copy data that is shared between the devices is stored by the device. In a step 902, local history data is stored in the device. The local history data keeps track of modifications made to the stored local copy of the shared data. It is stored as a list of elements, also referred to as nodes, each node representing a state of modification of said local copy, each node comprising:

a version identifier;

a list of file name and file hash pairs of files that are part of said shared data;

a type information indicating if said node results from an update operation on said local copy or if said node results from a merge operation between said local copy and another local copy stored by another of said devices; and

at least one link to an ancestor node.

In step 903, the method of storing is done.

1-7. (canceled)

8. A method of synchronization of shared data for use in a distributed storage system, wherein the method comprises the following steps, implemented by a local device initiating a synchronization of its local copy of shared data with said shared data stored in a remote device:
computing a local version identifier of said local copy of said shared data and requesting a current remote version identifier of the shared data stored in the remote device, said local version identifier being a string of characters, generated through hashing of a concatenated list of hashed tuples of filename and hashed file contents of files in said local copy of shared data;
if the remote version identifier is different than the local version identifier and the current remote version identifier is not in a local history data of modifications made to said local copy of said shared data, requesting remote history data from the remote device, said history data being a linked list of nodes in which each node represents a particular state of a local copy of said shared data stored by a device, and one of the nodes being marked as being a latest version of said local copy; otherwise, the method is finished;
determining, from a comparison between local history data and remote history data, of file delete and add operations applied since common ancestors of two versions which are common between two sets of history data and that resulted in a difference between said local version identifier and said current remote version identifier;
downloading files from the remote device to be added to the local device and deleting of files from the local device, according to the previous determining, thereby obtaining a new local state of modification of said shared data;
if the new local state of modification of said shared data differs from both said local version of shared data and said current remote version of said shared data, adding of a new node to the local history data comprising characteristics of the new local state of modification of said shared data, said characteristics comprising a version identifier, a list of file name and file hash pairs that are part of said shared data, and type information indicating that said new node results from a merge operation.

9. The method according to claim 8, wherein a base type node is created in said local history data if an update is made to one of the files in said local copy of said shared data, and wherein a merge type node is created if said local copy is synchronized with said shared data stored in a remote device.

10. The method according to claim 9, wherein, upon said update, a new version identifier for the created node is created by said hashing of said concatenated list.

11. A distributed storage system device, wherein the device comprises a processing unit, operably configured to initiate a synchronization of a local copy of shared data stored in said device with said shared data stored in a remote device, said processing unit being further operably configured:
to compute a local version identifier of said local copy of said shared data and requesting a current remote version identifier of the shared data stored in the remote device, said local version identifier being a string of characters, generated through hashing of a concatenated list of hashed tuples of filename and hashed file contents of files in said local copy of shared data;
to determine if the remote version identifier is different than the local version identifier and the current remote version identifier is not in a local history data of modifications made to said local copy of said shared data, requesting remote history data from the remote device, said history data being a linked list of nodes in which each node represents a particular state of a local copy of said shared data stored by a device, and one of the nodes being marked as being a latest version of said local copy;
to determine, from a comparison between local history data and remote history data, of file delete and add operations applied since common ancestors of two versions which are common between two sets of history data and that resulted in a difference between said local version identifier and said current remote version identifier;
to download files from the remote device to be added to the local device and to delete files from the local device, according to the previous determining from a comparison between said local history data and said remote history data, thereby obtaining a new local state of modification of said shared data;
to determine if the new local state of modification of said shared data differs from both said local version of shared data and said current remote version of said shared data, adding of a new node to the local history data comprising characteristics of the new local state of modification of said shared data, said characteristics comprising a version identifier, a list of file name and file hash pairs that are part of said shared data, and type information indicating that said new node results from a merge operation.

12. The device according to claim 11, wherein said processing unit is further operably configured to create a base type node in said local history data if an update is made to one of the files in said local copy of said shared data, and to create a merge type node if said local copy is synchronized with said shared data stored in a remote device.

13. The device according to claim 12, wherein said processing unit is further operably configured to, upon said update, create a new version identifier for the created node by said hashing of said concatenated list.
